(19) United States
(12) Patent Application Publication
(10) Pub. No.: US 2024/0291175 A1
(43) Pub. Date: Aug. 29, 2024

(54) CONNECTING TERMINAL AND WIRE WITH CONNECTING TERMINAL

(71) Applicants: AUTONETWORKS TECHNOLOGIES, LTD., Mie (JP); SUMITOMO WIRING SYSTEMS, LTD., Mie (JP); SUMITOMO ELECTRIC INDUSTRIES, LTD., Osaka (JP)

(72) Inventors: Hideki NOMURA, Osaka (JP); Kazuhiro WASHIO, Osaka (JP)

(21) Appl. No.: 18/572,719

(22) PCT Filed: Jun. 15, 2022
(86) PCT No.: PCT/JP2022/023892

§ 371 Date: Dec. 20, 2023

(30) Foreign Application Priority Data
Jun. 30, 2021 (JP) 2021-108596

(51) Int. Cl. H01R 4/18

(52) U.S. Cl. CPC H01R 4/185

(57) ABSTRACT

A connecting terminal includes a wire barrel section, an insulation barrel section, and a transition section. The wire barrel section can be crimped to a core wire exposed from a coating portion of a wire that includes the core wire and the coating portion coating the core wire. The insulation barrel section can be crimped to the coating portion. The transition section connects the wire barrel section and the insulation barrel section to each other. The transition section includes at least one protrusion on a face that opposes the wire when the wire is crimped by the wire barrel section and the insulation barrel section.

### TECHNICAL FIELD

The present disclosure relates to a connecting terminal and a wire with connecting terminal.

### BACKGROUND

Conventionally, in the fields of automobiles, office automation equipment, home appliances, and the like, connecting terminals are generally used at joints of wires for transmitting and receiving electricity. These connecting terminals have a wire barrel section for crimping to a core wire exposed from a coating portion and an insulation barrel section for crimping to the coating portion coating the core wire. A connecting terminal disclosed in Patent Document 1 is a known example of such connecting terminals.

### PRIOR ART DOCUMENT

### Patent Document

Patent Document 1: JP 2018-067372 A

### SUMMARY OF THE INVENTION

### Problems to be Solved

The terminal disclosed in Patent Document 1 is a member formed by performing a press working process and the like on a metal sheet member, which is a conductive sheet member, and includes a partner conductor connecting section that is configured to come into direct contact with a partner conductor, which is a partner electrical connecting element, and a wire connecting section that is connected to the partner conductor connecting section. The wire connecting section includes a leading-end side connection portion, a core wire crimping portion, an intermediate connection portion, and a coating crimping portion. The leading-end side connection portion, the core wire crimping portion, the intermediate connection portion, and the coating crimping portion are formed in line along a straight line. Here, there is a demand for reducing the transmission of vibration of the wire to a crimped portion of a core wire.

Therefore, an object of the present disclosure is to reduce the transmission of vibration of a wire to a portion of a core wire that is crimped by a wire barrel section.

### Means to Solve the Problem

A connecting terminal of the present disclosure is a connecting terminal including: a wire barrel section, an insulation barrel section, and a transition section, wherein the wire barrel section is configured to be crimped to a core wire exposed from a coating portion of a wire that includes the core wire and the coating portion coating the core wire, the insulation barrel section is configured to be crimped to the coating portion, and the transition section connects the wire barrel section and the insulation barrel section to each other and includes at least one protrusion on a face that opposes the wire when the wire is crimped by the wire barrel section and the insulation barrel section.

A wire with connecting terminal of the present disclosure is a wire with connecting terminal including: a connecting terminal including a wire barrel section, an insulation barrel section, and a transition section, the wire barrel section being configured to be crimped to a core wire exposed from a coating portion of a wire that includes the core wire and the coating portion coating the core wire, the insulation barrel section being configured to be crimped to the coating portion, and the transition section connecting the wire barrel section and the insulation barrel section to each other and including at least one protrusion on a face that opposes the wire when the wire is crimped by the wire barrel section and the insulation barrel section; and the wire crimped by the connecting terminal.

### EFFECT OF THE INVENTION

According to the present disclosure, it is possible to reduce the transmission of vibration of a wire to a core wire that is crimped by a wire barrel section.

### BRIEF DESCRIPTION OF THE DRAWINGS

FIG. 1 is a perspective view of a wire with connecting terminal according to Embodiment 1 of the present disclosure, which is shown disassembled into a connecting terminal and a wire.

FIG. 2 is an explanatory diagram illustrating a state in which first projecting portions of a wire barrel section and second projecting portions of an insulation barrel section, which are included in the connecting terminal of the wire with connecting terminal according to Embodiment 1 of the present disclosure, are bent.

FIG. 3 is a rear view of the connecting terminal according to Embodiment 1 of the present disclosure.

FIG. 4 is a cross-sectional view showing a cross section taken along IV-IV in FIG. 1.

FIG. 5 is a cross-sectional view showing a cross section taken along V-V in FIG. 1.

FIG. 6 is a partially enlarged view showing a transition section of a connecting terminal according to Embodiment 2 of the present disclosure in an enlarged manner.

FIG. 7 is a partially enlarged view showing a transition section of a connecting terminal according to Embodiment 3 of the present disclosure in an enlarged manner.

FIG. 8 is a cross-sectional view showing a protrusion according to Embodiment 3 of the present disclosure.

FIG. 9 is a perspective view of a wire with connecting terminal according to a variation of Embodiment 1 of the present disclosure, which is shown disassembled into a connecting terminal and a wire.

FIG. 10 is a rear view of a connecting terminal according to a variation of Embodiment 3 of the present disclosure.

FIG. 11 is an explanatory diagram illustrating a preferred arrangement of a plurality of protrusions.

### DETAILED DESCRIPTION TO EXECUTE THE INVENTION

### Description of Embodiments of Present Disclosure

First, aspects of the present disclosure will be listed and described.

A connecting terminal and a wire with connecting terminal according to the present disclosure are as follows.

(1) A connecting terminal including: a wire barrel section, an insulation barrel section, and a transition section, wherein the wire barrel section is configured to be crimped to a core wire exposed from a coating portion of a wire that includes the core wire and the coating portion coating the core wire, the insulation barrel section is configured to be crimped to the coating portion, and the transition section connects the wire barrel section and the insulation barrel section to each other and includes at least one protrusion on a face that opposes the wire when the wire is crimped by the wire barrel section and the insulation barrel section.

With this configuration, even in the transition section of the connecting terminal, the at least one protrusion can come into contact with the wire. This configuration makes it possible that a portion that reduces vibration of the wire is provided between the wire barrel section and the insulation barrel section. Thus, the transmission of vibration to a crimped portion of the core wire of the wire that is crimped by the wire barrel section is reduced.

(2) The transition section may be inclined so as to gradually approach the wire while extending from the insulation barrel section toward the wire barrel section.

With this configuration, a gradual shape change from the insulation barrel section toward the wire barrel section can be achieved. This eliminates the need to form an abruptly changing portion in the transition section. The gradually inclined transition section is provided with the at least one protrusion for reducing vibration.

(3) The at least one protrusion may include a plurality of protrusions.

This configuration increases the number of points of contact between the wire and the connecting terminal even further. Thus, the transmission of vibration to the crimped portion of the core wire that is crimped by the wire barrel section is reduced even further.

(4) Among the plurality of protrusions, at least two protrusions may be disposed in the same plane which is perpendicular to a longitudinal direction of the connecting terminal.

With this configuration, a plurality of protrusions can come into contact with the wire in a predetermined plane. Vibration of the wire is therefore effectively reduced in the connecting terminal.

(5) Among the plurality of protrusions, at least one protrusion may be disposed at a different position from each other protrusion in a longitudinal direction the connecting terminal.

With this configuration, a plurality of protrusions can come into contact with the wire at a plurality of positions that are dispersed in the longitudinal direction of the wire. Vibration of the wire is therefore effectively reduced in the connecting terminal.

(6) Three or more of the protrusions may be disposed in the same plane which is perpendicular to a longitudinal direction of the connecting terminal, and a diameter of an imaginary circle passing through vertices of the three or more protrusions may be equal to or smaller than a diameter of the wire.

With this configuration, the wire is pressed by the three or more protrusions in the same plane. Thus, the transmission of vibration to the crimped portion of the core wire that is crimped by the wire barrel section is reduced even further. Note that the “diameter of the wire” refers to the diameter of a portion of the wire that is to come into contact with the protrusions.

(7) A wire with connecting terminal of the present disclosure is a wire with connecting terminal, including: the connecting terminal according to any one of clauses (1) to (6); and the wire crimped by the connecting terminal.

With this configuration, even in the transition section of the wire with connecting terminal, the at least one protrusion can come into contact with the wire. This configuration makes it possible that a portion that reduces vibration of the wire is provided between the wire barrel section and the insulation barrel section. Thus, the transmission of vibration to a crimped portion of the core wire of the wire that is crimped by the wire barrel section is reduced.

(8) The core wire may be a single-core wire.

With this configuration, even in the case of a single-core wire, which is particularly stiff and transmits vibration well, the transmission of vibration to the crimped portion of the core wire that is crimped by the wire barrel section is reduced.

(9) The at least one protrusion may abut on the core wire or the coating portion.

With this configuration, the connecting terminal can reliably come into contact with the wire in the transition section. Thus, the transmission of vibration to the crimped portion of the core wire that is crimped by the wire barrel section is reduced.

### Detailed Description of Embodiments of Present Disclosure

Specific examples of a connecting terminal and a wire with connecting terminal of the present disclosure will be described below with reference to the drawings. Note that the present invention is not limited to these illustrative examples, but rather is defined by the claims, and all changes that come within the meaning and range of equivalency of the claims are intended to be embraced therein.

In the drawings, the configuration may be partially exaggerated or simplified for convenience of description. Also, the size ratios of various portions may differ from one drawing to another. The terms “parallel” and “orthogonal” as used herein encompass not only “precisely parallel” and “precisely orthogonal” but also “substantially parallel” and “substantially orthogonal”, as long as the functions and effects of the embodiments are exhibited.

In the drawings, orthogonal coordinate axes X, Y, and Z (right-handed coordinate system) are shown as appropriate to illustrate directions. On these coordinate axes, the direction X indicates the longitudinal direction of the connecting terminal, and the direction Y indicates the width direction of the connecting terminal. The width direction of the connecting end is a direction in which a pair of first projecting portions 11b, which will be described later, are lined up. The direction Z is the height direction of the connecting terminal and indicates a direction that is orthogonal to the directions X and Y. Hereinafter, one side in the direction X may be referred to as the “+X side”, and the opposite side as the “−X side”. The same applies to the Y-axis and the Z-axis, and the “+Z side” indicates a side on which a face of the connecting terminal that comes into contact with the wire is located, while the “−Z side” indicates a side on which a face of the connecting terminal that does not come into contact with the wire is located.

### Embodiment 1

Wire with Connecting Terminal 1

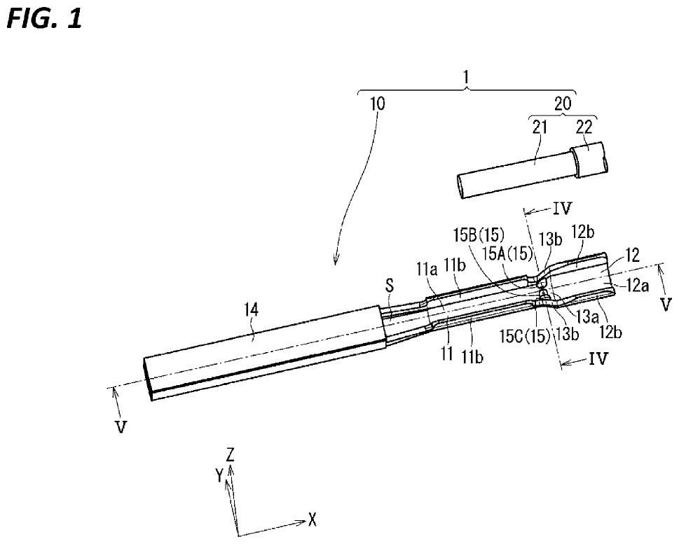

An outline of the structure of a wire with connecting terminal according to Embodiment 1 will be described below. FIG. 1 is a perspective view of a wire with connecting terminal 1 according to an embodiment of the present disclosure, which is shown disassembled into a connecting terminal 10 and a wire 20. The wire with connecting terminal 1 includes the connecting terminal 10 and the wire 20 crimped by the connecting terminal 10.

The wire 20 according to the present embodiment is, for example, a single-core wire. The single-core wire includes a core wire 21 and a coating portion 22 coating the core wire 21. The coating portion 22 is made of, for example, an insulating material. Here, for example, a core with a very small diameter (e.g., with a cross-sectional area of about 0.05 mm²) is used as the core wire 21. Especially in recent years, reductions in the weight and size of entire devices have been in demand, and therefore wires have become smaller in diameter. Under such circumstances, there is a growing demand for a wire 20 in which a core wire 21 with a very small diameter is used. When there is desire for such a core wire 21 with a very small diameter to have a predetermined strength, a single-core wire is used as the core wire 21, instead of a stranded wire. The reason for this is that a single-core wire is stiffer and stronger than a stranded wire having the same diameter. On the other hand, a single-core wire has the feature of transmitting vibration well, because of its high stiffness. Therefore, when using such a single-core wire with a very small diameter, it is particularly necessary to devise a method for reducing the vibration. However, the invention of the present disclosure is applicable not only to a single-core wire but also to a stranded wire.

### Connecting Terminal 10

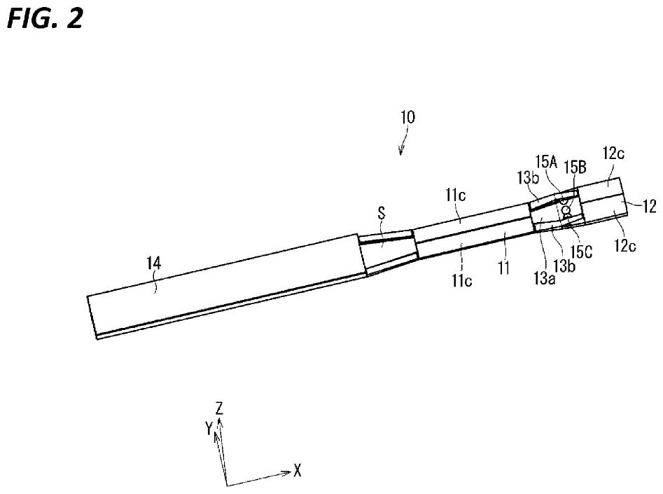

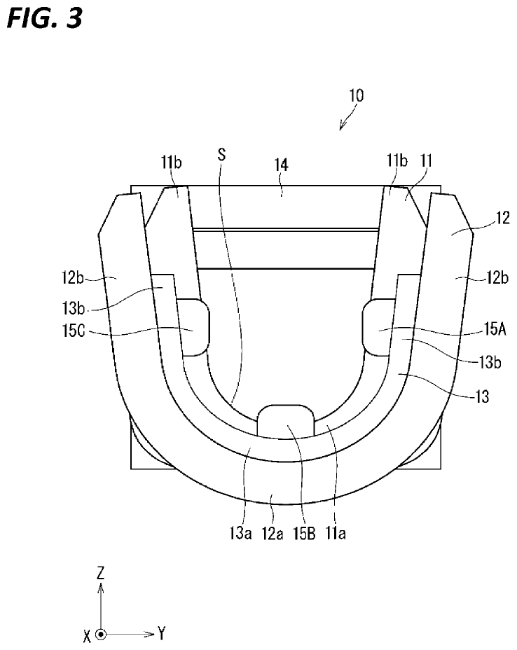

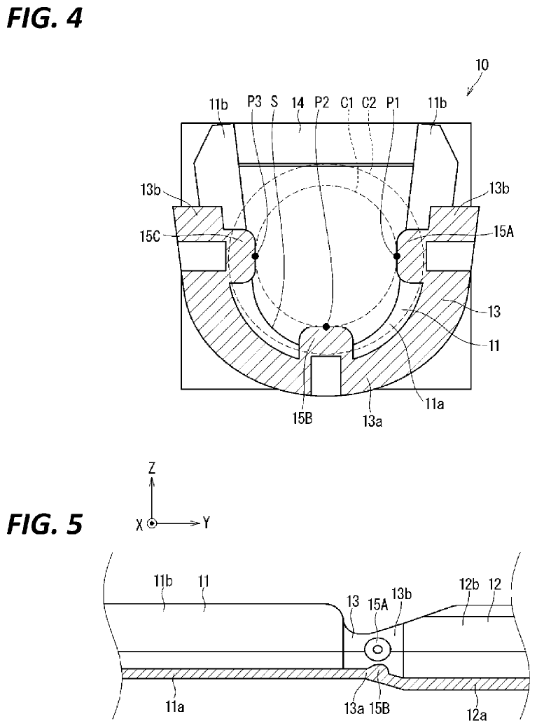

An outline of the structure of the connecting terminal 10 according to Embodiment 1 will be described below. FIG. 2 is an explanatory diagram illustrating a state in which first projecting portions 11b of a wire barrel section 11 and second projecting portions 12b of an insulation barrel section 12 are bent. The wire 20 is not shown in FIG. 2. FIG. 3 is a rear view of the connecting terminal 10 according to the embodiment of the present disclosure, and FIG. 4 is a cross-sectional view showing a cross section taken along IV-IV in FIG. 1, along with an imaginary circle C1 and an imaginary circle C2. FIG. 5 is a cross-sectional view showing a cross section taken along V-V in FIG. 1.

The connecting terminal 10 is, for example, formed by performing a press working process on sheet metal of copper or a copper alloy. The connecting terminal 10 includes the wire barrel section 11, the insulation barrel section 12, and a transition section 13. The connecting terminal 10 also includes a main body section 14. The main body section 14 is a section configured to be fitted to a partner terminal. The main body section may be formed in the form of a pin, a tab, or a tube. In the present embodiment, the main body section 14 is a section that is formed in the form of a tube configured to be fitted to a male terminal.

### Wire Barrel Section 11 and Insulation Barrel Section 12

The wire includes the core wire 21 and the coating portion 22 coating the core wire 21, and the wire barrel section 11 can be crimped to the core wire 21 exposed from the coating portion 22. The wire barrel section 11 has a first bottom wall portion 11a and the pair of first projecting portions 11b projecting upward from two respective edges of the first bottom wall portion 11a.

The insulation barrel section 12 can be crimped to the coating portion 22. The insulation barrel section 12 has a second bottom wall portion 12a and the pair of second projecting portions 12b projecting upward from two respective edges of the second bottom wall portion 12a. Note that the wire barrel section 11 and the insulation barrel section 12 are of the open barrel type.

During a crimping operation of crimping the wire barrel section 11 to the wire 20, distal end portions of the pair of first projecting portions 11b are bent toward the middle and downward with a crimper (not shown). A pair of bent pieces 11c (see FIG. 2) that have thus been deformed press the core wire 21 from above. In this state, the first bottom wall portion 11a and the pair of bent pieces 11c surround the core wire 21 and hold the core wire 21. The first bottom wall portion 11a and the pair of bent pieces 11c are in contact with the outer circumferential surface of the core wire 21, and therefore the core wire 21 and the wire barrel section 11 are kept in electrical contact with each other. On the other hand, during a crimping operation of crimping the insulation barrel section 12 to the wire 20, the pair of second projecting portions 12b are bent toward the middle and downward with a crimper (not shown). A pair of bent pieces 12c (see FIG. 2) that have thus been deformed press the coating portion 22 from above. Thus, in this state, the second bottom wall portion 12a and the pair of bent pieces 12c surround the coating portion 22 and hold the coating portion 22. In this manner, the wire 20 is crimped by the wire barrel section 11 and the insulation barrel section 12. The insulation barrel section 12 holds the core wire 21 on the side of the wire barrel section 11 on which the wire 20 extends, and therefore, if the wire 20 is pulled, the pulling force is unlikely to be transmitted to an end portion of the core wire 21. In addition, vibration of the wire 20 is suppressed by the wire barrel section 11, and therefore the vibration is unlikely to be transmitted to the end portion of the core wire 21. Note that the first projecting portions 11b may have different lengths, and the second projecting portions 12b may have different lengths. In this case, it is preferable that the distal end portion of the first projecting portion 11b having the longer length extends to and overlaps the distal end portion of the first projecting portion 11b having the shorter length, and the same applies to the second projecting portions 12b.

### Transition Section 13

The transition section 13 is substantially U-shaped in cross section perpendicular to the longitudinal direction (direction X) (see FIGS. 3 and 4). The transition section 13 is disposed between the wire barrel section 11 and the insulation barrel section 12 and connects the wire barrel section 11 and the insulation barrel section 12 to each other. More specifically, the transition section 13 includes a third bottom wall portion 13a and a pair of third projecting portions 13b. The third bottom wall portion 13a is located between the first bottom wall portion 11a and the second bottom wall portion 12a.

The transition section 13, for example, is inclined so as to gradually approach the wire 20 while extending from the insulation barrel section 12 toward the wire barrel section 11. This can be described as follows. Since the coating portion 22 coats the core wire 21, the coating portion 22 is thicker than the core wire 21. Therefore, the insulation barrel section 12 is wider and taller than the wire barrel section 11, both before and after crimping. If the insulation barrel section 12 is directly connected to the wire barrel section 11, it is conceivable to provide a portion where there is an abrupt change in shape, such as a step portion, between the insulation barrel section 12 and the wire barrel section 11 in order to abruptly change the width and height. In that case, it is necessary to excessively change the shape of the metal sheet, and also the process for achieving this may be difficult. Forming the transition section 13 in a shape whose width and height gradually decrease from the insulation barrel section 12 toward the wire barrel section 11 makes it possible to eliminate the need to make an excessive shape change, and also process a connecting section between the insulation barrel section 12 and the wire barrel section 11 with ease.

More specifically, the transition section 13 includes the third bottom wall portion 13a and the pair of third projecting portions 13b. The third bottom wall portion 13a is arc-shaped in horizontal cross section (cross section that is orthogonal to the longitudinal direction of the terminal), and is provided between and continuous with the first bottom wall portion 11a and the second bottom wall portion 12a. The second bottom wall portion 12a has a larger radius of curvature than the first bottom wall portion 11a, and the third bottom wall portion 13a is formed in a shape whose radius of curvature gradually decreases from the second bottom wall portion 12a toward the first bottom wall portion 11a.

The pair of third projecting portions 13b project in the same direction as the pair of first projecting portions 11b and the pair of second projecting portions 12b from two respective edges of the third bottom wall portion 13a. The pair of third projecting portions 13b may be parallel to each other or may extend such that the distance therebetween gradually increases toward their distal end side. Distal end edges of the pair of third projecting portions 13b are located closer to the third bottom wall portion 13a than distal end edges of the pair of first projecting portions 11b and the pair of second projecting portions 12b. During crimping, the pair of first projecting portions 11b and the pair of second projecting portions 12b can bend mainly at positions that are located closer to the distal end side than the pair of third projecting portions 13b (see FIG. 2).

The transition section 13 also includes at least one protrusion 15 on a face S that opposes the wire 20 (or the core wire 21) when the wire 20 is crimped by the wire barrel section 11 and the insulation barrel section 12. In the present embodiment, as shown in FIGS. 1 to 4, the transition section 13 includes three protrusions 15. Note that the transition section 13 is not limited to a configuration in which it includes three protrusions 15. The number of protrusions 15 may be one, or two or four or more. However, from the viewpoint of reducing vibration of the wire 20, a configuration in which the transition section 13 includes a plurality of protrusions 15 is preferred. The at least one protrusion 15 is preferably formed through a press working process. In the case where the connecting terminal 10 is formed through a press working process, a protrusion 15 is formed by being pressed from the side opposite to the S side, and therefore a depression is formed on the side opposite to the S side.

In the connecting terminal 10, among the plurality of protrusions 15, at least two protrusions 15A and 15B are disposed in the same plane (imaginary YZ plane) which is perpendicular to the longitudinal direction (direction X) of the connecting terminal 10. For example, all three protrusions 15A, 15B, and 15C are disposed in the same plane (YZ plane) which is perpendicular to the longitudinal direction (direction X) of the connecting terminal 10. In other words, all three protrusions 15A, 15B, and 15C are disposed at positions that are the same in the longitudinal direction (direction X) of the connecting terminal 10 but different in the circumferential direction of the transition section 13. More specifically, one protrusion 15 is formed in the middle of the third bottom wall portion 13a in the width direction, and two protrusions 15 are respectively formed in the pair of third projecting portions 13b. Thus, the plurality of protrusions come into contact with the wire 20 at respective positions in the same plane which is perpendicular to the longitudinal direction of the connecting terminal 10. Vibration of the wire 20 is therefore reduced by the connecting terminal 10. Specifically, vibration that is produced when a vehicle is moving is transmitted through the portion of the wire 20 that is crimped by the insulation barrel section 12. Providing the protrusions 15 serving as portions that come into contact with the wire 20 enables the transition section 13 to suppress this vibration. Thus, vibration of the wire 20 (core wire 21) is reduced in the portion of the wire 20 (core wire 21) that is crimped by the wire barrel section 11.

Note that in the present embodiment, there is no material such as a corrosion inhibitor between the connecting terminal 10 and the wire 20. Therefore, there is a space between the transition section 13 and the wire 20. Specifically, a gap is formed between one protrusion 15 (e.g., 15A) of the transition section 13, another protrusion 15 (e.g., 15B) that is next to the former protrusion 15, and the wire 20.

A case where the protrusions 15A, 15B, and 15C hold the wire 20 by abutting on the core wire 21 and a case where the protrusions 15A, 15B, and 15C hold the wire 20 by abutting on the coating portion 22 by abutting on the coating portion 22 are conceivable. The case where the protrusions hold the wire 20 by abutting on the core wire 21 and the case where the protrusions hold the wire 20 by abutting on the coating portion 22 will be described below.

In the case where the protrusions 15A, 15B, and 15C abut on the core wire 21, the plurality of protrusions 15A, 15B, and 15C abut on the core wire 21 at different positions in the circumferential direction of the core wire 21. For example, even when vibration is transmitted in various directions through the wire 20, it is expected that any of the protrusions 15A, 15B, and 15C can effectively abut on the core wire 21 from a direction in which that protrusion suppresses the vibration.

In the case where the protrusions 15A, 15B, and 15C abut on the core wire 21, the diameter of an imaginary circle C1 passing through the vertices P1, P2, and P3 of the three protrusions 15 shown in FIG. 4 is smaller than the diameter of an imaginary circle C2 corresponding to the core wire 21 of the wire 20 in a state in which it is not supported by the protrusions 15 (i.e., a state in which it is not pressed by the protrusions 15). With this configuration, the core wire 21 of the wire 20 is pressed by the three protrusions 15 at positions that are lined up in the same plane. When the wire 20 is fixed by the protrusions 15 abutting on the core wire 21, the wire 20 can be firmly fixed by the protrusions 15, because the core wire 21 is stiffer than the coating portion 22. When the core wire 21 of the wire 20 is brought into contact with the protrusions 15 at positions on the imaginary circle C1, which is smaller in diameter than the imaginary circle C2 corresponding to the core wire 21, at least the tops of the protrusions 15 deform or the core wire 21 deforms, and therefore the core wire 21 of the wire 20 is strongly pressed by the protrusions 15. For example, during the crimping operation of the wire barrel section 11 or the insulation barrel section 12, the transition section 13 is also bent inward as the barrel section is crimped. It is conceivable that the force by which the transition section 13 is bent as described above may cause the protrusions 15 to bite into the core wire 21. Thus, vibration of the wire 20 is reduced. The diameter of the imaginary circle C1 may be equal to the diameter of the imaginary circle C2 corresponding to the core wire 21. Even in such a case where the diameter of the imaginary circle C1 is equal to the diameter of the imaginary circle C2, the wire 20 can be firmly fixed by the protrusions 15.

On the other hand, in the case where the protrusions 15A, 15B, and 15C abut on the coating portion 22, the plurality of protrusions 15A, 15B, and 15C abut on the coating portion 22 at different positions in the circumferential direction of the coating portion 22. For example, even when vibration is transmitted in various directions through the wire 20, it is expected that any of the protrusions 15A, 15B, and 15C can effectively abut on the coating portion 22 from a direction in which that protrusion suppresses the vibration.

The diameter of the imaginary circle C1 is smaller than the diameter of the imaginary circle C2 corresponding to the wire 20 in a state in which it is not supported by the protrusions 15 (i.e., a state in which it is not depressed by being pressed by the protrusions 15). With this configuration, the wire 20 is pressed by the three protrusions 15 at positions that are lined up in the same plane. The protrusions 15 abut on the coating portion 22, for example. The coating portion 22 is preferably made of a flexible material such as vinyl chloride or polyethylene. When the coating portion 22 is brought into contact with the protrusions 15 at positions on the imaginary circle C1, which is smaller in diameter than the imaginary circle C2 that encloses the coating portion 22, the coating portion 22 pressed by the protrusions 15 deforms, and therefore the wire 20 is strongly pressed by the protrusions 15. Thus, vibration of the wire 20 is reduced.

Note that the present invention is not limited to a configuration in which the connecting terminal 10 has three protrusions 15 in the same plane (YZ plane) which is perpendicular to the longitudinal direction (direction X) of the connecting terminal 10. From the viewpoint of increasing the number of points of contact, or increasing the area of contact, between the wire 20 and the connecting terminal 10, the protrusions 15 may be arranged not only in the same plane (YZ plane) which is perpendicular to the longitudinal direction (direction X), but also at different positions in the longitudinal direction.

In addition, it is sufficient that the transition section 13 includes at least one protrusion 15. However, from the viewpoint of improving the supporting force by clamping the core wire 21 or the coating portion 22 with a plurality of protrusions 15, it is preferable that the transition section 13 includes two or more protrusions 15 and is configured to be able to clamp the core wire 21 or the coating portion 22 therebetween.

As described above, the configuration in which the transition section 13 includes a protrusion 15 makes it possible for the connecting terminal 10 to come into contact with the wire 20 even in the transition section 13. Therefore, a portion that reduces vibration of the wire 20 can be provided between the wire barrel section 11 and the insulation barrel section 12. Thus, the transmission of vibration to a crimped portion of the core wire 21 of the wire 20 that is crimped by the wire barrel section 11 is reduced.

For example, when a reduction in the size of the insulation barrel section 12 is needed to meet the demand for miniaturization or the like, and a transition section 13 having a certain length has to be provided between the insulation barrel section 12 and the wire barrel section 11 due to processing restrictions or the like, the transmission of vibration through the wire 20 in such a configuration can be effectively reduced by a protrusion 15 provided in the transition section 13.

As shown in FIG. 5, the transition section 13, for example, is inclined so as to gradually approach the wire 20 while extending from the insulation barrel section 12 toward the wire barrel section 11. With this configuration, a gradual shape change from the insulation barrel section 12 toward the wire barrel section 11 can be achieved. This eliminates the need to form an abruptly changing portion in the transition section 13. Specifically, the gradually inclined shape eliminates the need for a process for forming a step portion or the like. Such a shape is beneficial to press working, where it is difficult to form a step shape, in particular.

It is preferable that a plurality of protrusions 15 are provided. The number of protrusions 15 is not limited to three as described above, and may be two or four or more. In the case where the number of protrusions 15 is four or more, there are more points of contact with the wire 20 than in the case where the number of protrusions 15 is three, and vibration of the wire 20 is therefore reduced even further. On the other hand, in the case where the number of protrusions 15 is two, there are fewer points of contact with the wire 20, but this case is preferable to the case where the number of protrusions 15 is three in consideration of reducing processing man-hours. Note that even when the number of protrusions 15 is one, vibration of the wire 20 is reduced as long as there is a point of contact with the wire 20.

### Embodiment 2

### Connecting Terminal 210

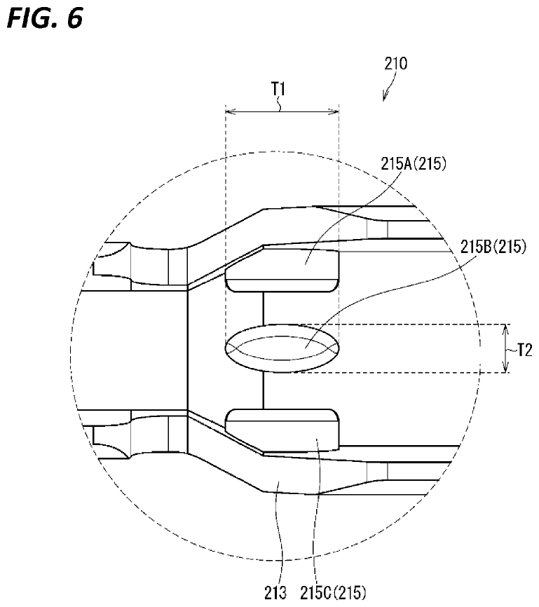

FIG. 6 is a partially enlarged view showing a transition section 213 of a connecting terminal 210 according to Embodiment 2 of the present disclosure in an enlarged manner.

The connecting terminal 210 according to Embodiment 2 includes the transition section 213 instead of the transition section 13 of Embodiment 1. The transition section 213 has the same configuration as the transition section 13 above, except for a protrusion 215. The following description focuses on the configuration related to the protrusion 215.

### Transition Section 213

As shown in FIG. 6, the transition section 213 includes three protrusions 215.

A protrusion 215B has, for example, a shape that is elongated in the longitudinal direction (direction X) of the connecting terminal 210. The length T1 of the protrusion 215B in the longitudinal direction (direction X) of the connecting terminal 210 is longer than the length T2 thereof in a direction perpendicular to the longitudinal direction (direction X) of the connecting terminal 210. In the present embodiment, the same configuration is adopted for protrusions 215A and 215C as well. Thus, the area of contact between the connecting terminal 210 and the wire 20 is increased. Therefore, the wire 20 is effectively immobilized in the connecting terminal 210. Thus, vibration of the wire 20 that is produced when a vehicle is moving is reduced.

In addition, since the protrusion 215B is elongated in the longitudinal direction of the wire 20, the single protrusion 215B can come into contact with the wire 20 at different positions in the longitudinal direction of the wire 20. Therefore, transverse vibration transmitted through the wire 20 is effectively reduced by the protrusions 215.

In the present embodiment, the three protrusions 215 are located at dispersed positions in a plane that is perpendicular to the longitudinal direction of the connecting terminal 210. As in Embodiment 1 above, the number of protrusions 215B may be one, or two or more.

### Embodiment 3

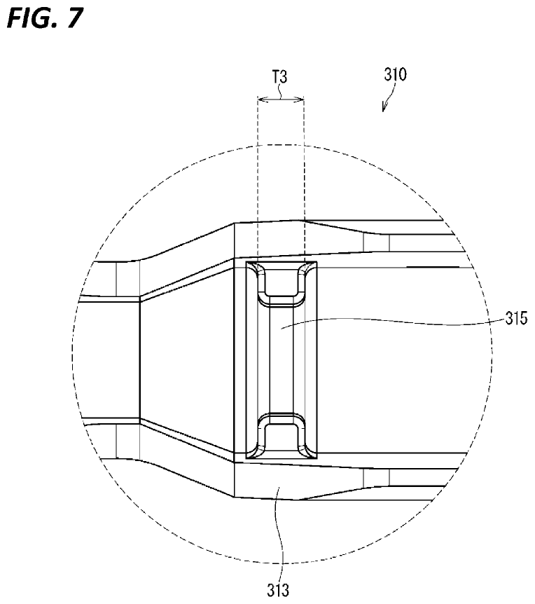

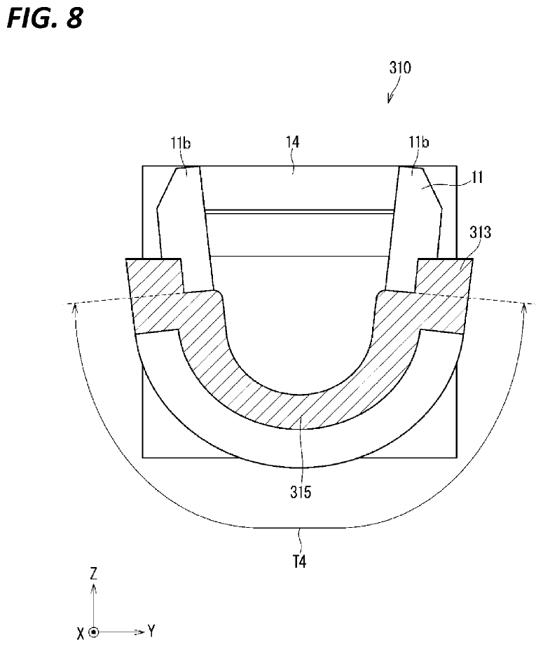

Connecting Terminal 310 FIG. 7 is a partially enlarged view showing a transition section 313 of a connecting terminal according to Embodiment 3 of the present disclosure in an enlarged manner. FIG. 8 is a side sectional view showing a cross section of a protrusion 315 according to Embodiment 3 of the present disclosure as viewed from a side of the connecting terminal.

The connecting terminal 310 includes the transition section 313 instead of the transition section 13 of Embodiment 1. The transition section 313 has the same configuration as the transition section 13 above, except for the protrusion 315. The following description focuses on the configuration related to the protrusion 315.

### Transition Section 313

The transition section 313 includes one protrusion 315.

The protrusion 315 has, for example, a shape that is elongated in a plane (YZ plane) perpendicular to the longitudinal direction (direction X) of the connecting terminal 310. That is to say, the protrusion 315 has a shape that is elongated in the circumferential direction of the transition section 313. The length T4 of the protrusion 315 in a direction perpendicular to the longitudinal direction (direction X) of the connecting terminal 310 is longer than the length T3 thereof in the longitudinal direction (direction X) of the connecting terminal 310. Thus, the length of contact between the connecting terminal 310 and the protrusion 315 in the circumferential direction of the wire 20 is increased. This enhances the effect of reducing vibration transmitted in various directions through the wire 20. Thus, vibration of the wire 20 that is produced when a vehicle is moving is reduced.

Note that the number of protrusions 315 is not limited to one. A configuration may also be adopted in which a plurality of protrusions 315 are arranged side by side at intervals in the longitudinal direction (direction X) of the connecting terminal 310. In that case, as in Embodiment 2, the protrusions 315 can come into contact with the wire 20 at different positions in the longitudinal direction of the wire 20. Therefore, transverse vibration transmitted through the wire 20 is effectively reduced by the protrusions 315.

### Variation 1

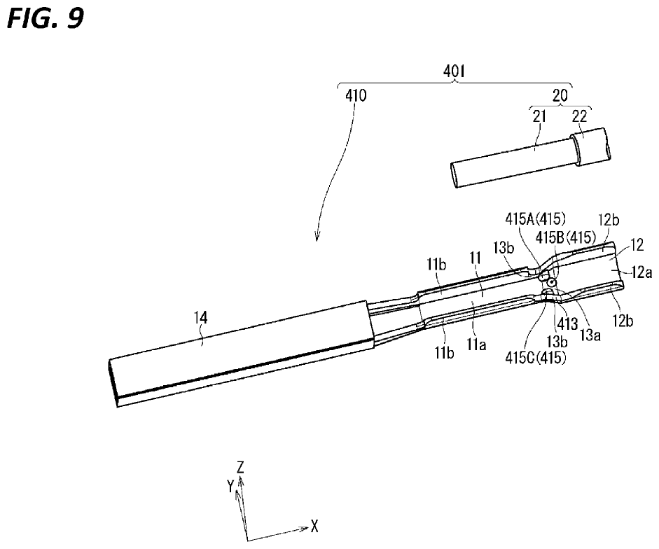

FIG. 9 is a perspective view of a wire with connecting terminal 401 according to a variation of Embodiment 1, which is shown disassembled into a connecting terminal 410 and the wire 20.

The connecting terminal 410 differs from the connecting terminal 10 of Embodiment 1 in that the connecting terminal 410 includes a transition section 413 instead of the transition section 13. The transition section 413 has the same configuration as the transition section 13 above, except for a protrusion 415. The following description focuses on the configuration related to the protrusion 415.

In the transition section 13 of Embodiment 1, all the protrusions 15A, 15B, and 15C are disposed in the same plane (YZ plane) which is perpendicular to the longitudinal direction (direction X) of the connecting terminal 10. In contrast, in the connecting terminal 410, among a plurality of protrusions 415A, 415B, and 415C, at least two protrusions 415A and 415C are disposed in the same plane which is perpendicular to the longitudinal direction of the connecting terminal 10. With this configuration, a plurality of (here, two) protrusions 415A and 415C can come into contact with the wire 20 in a predetermined plane. Vibration of the wire 20 is therefore effectively reduced in the connecting terminal 10.

In addition, among the plurality of protrusions 415A, 415B, and 415C, at least one protrusion 415B is disposed at a different position from the other protrusions 415A and 415C in the longitudinal direction (direction X) of the connecting terminal 410. With this configuration, a plurality of (here, two) protrusions 415A and 415B (or 415B and 415C) can come into contact with the wire 20 at a plurality of positions that are dispersed in the longitudinal direction of the wire 20. With such a configuration, transverse vibration transmitted through the wire 20 is effectively reduced by the protrusions 415. Vibration of the wire 20 is therefore effectively reduced in the connecting terminal 10.

More specifically, the two protrusions 415A and 415C respectively formed in the pair of third projecting portions 13b are disposed at the same position in the longitudinal direction of the connecting terminal 410, and the protrusion 415B formed in the third bottom wall portion 13a is disposed at a different position from the other protrusions 415A and 415C in the longitudinal direction of the connecting terminal 410, here, at a position that is close to the insulation barrel section 12.

The above-described connecting terminal 410 can also come into contact with the wire 20 even in the transition section 413, because of the configuration in which the protrusions 415 are provided. Therefore, a portion that reduces vibration of the wire 20 can be provided between the wire barrel section 11 and the insulation barrel section 12. This enhances the vibration reducing effect of the connecting terminal 410 on the wire 20. Vibration of the wire 20 that is produced when a vehicle is moving is therefore reduced.

Moreover, since at least two protrusions 415A and 415C, among the plurality of protrusions 415A, 415B, and 415C, are disposed at positions shifted from each other in the same plane which is perpendicular to the longitudinal direction (direction X) of the connecting terminal 410, the plurality of (here, two) protrusions 415 in a predetermined plane (plane that is parallel to the YZ plane) which is perpendicular to the longitudinal direction (direction X) of the connecting terminal 410 the plurality of protrusions 415A, 415B, and 415C come into contact with the wire 20 at different positions in the longitudinal direction of the wire 20. Transverse vibration of the wire 20 is therefore effectively reduced by the plurality of protrusions 415A, 415B, and 415C.

### Variation 2

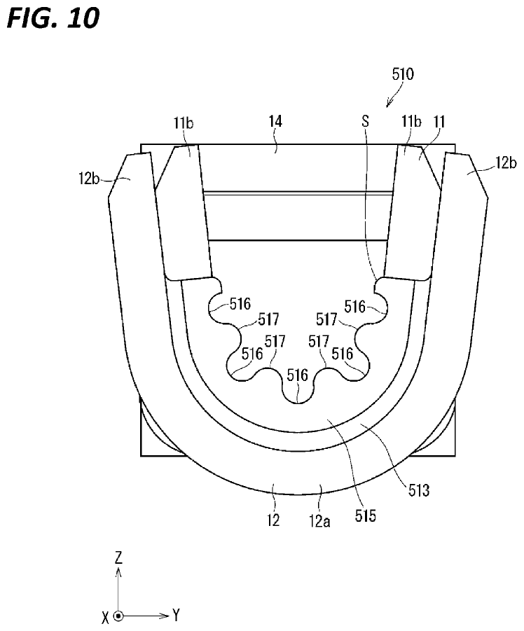

FIG. 10 is a rear view of a connecting terminal 510 according to a variation of Embodiment 3. The connecting terminal 510 differs from the connecting terminal 310 of Embodiment 3 in that the connecting terminal 510 includes a transition section 513 instead of the transition section 313. The transition section 513 has the same configuration as the transition section 313 above, except for a protrusion 515. The following description focuses on the configuration related to the protrusion 515.

The transition section 513 also includes a protrusion 515 having an elongated shape in a plane (YZ plane) perpendicular to the longitudinal direction (direction X) of the connecting terminal 310. The protrusion 515 further has an uneven shape along the elongation direction. Specifically, valley portions 516 and mountain portions 517 are alternately formed on the face S of the protrusion 515 that is configured to come into contact with the wire 20. The number of valley portions 516 and the number of mountain portions 517 may be one or more than one. With such valley portions 516 and mountain portions 517, portions that come into strong contact with the wire 20 and portions that come into weak contact with the wire 20 are alternately present around the wire 20. Thus, the effect of reducing vibration of the wire 20 can be enhanced even further.

### ADDITIONAL REMARKS

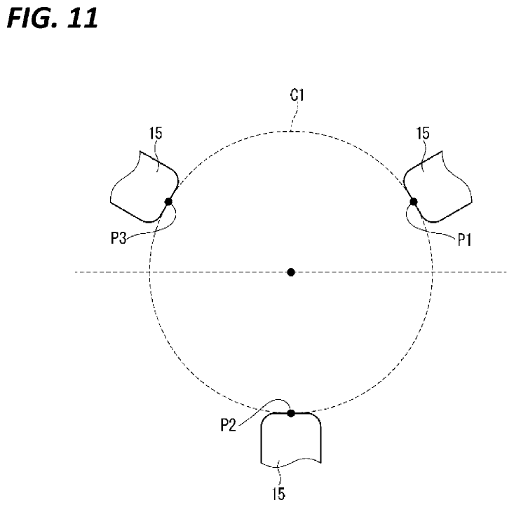

FIG. 11 is an explanatory diagram illustrating a preferred arrangement of the imaginary circle C1 and the protrusions 15 of Embodiment 1. The plurality of protrusions 15 may be dispersed over a region corresponding to an arc that is half or greater than half the imaginary circle C1.

For example, if three or more protrusions 15 are dispersed over a region corresponding to an arc that is greater than half the imaginary circle C1, the three or more protrusions 15 can surround the wire 20 and support the wire 20 so as to prevent the wire 20 from coming out through a space between the protrusions 15 (points P1, P2, and P3 in FIG. 11). Thus, the wire 20 can be effectively clamped and vibration can therefore be effectively suppressed.

In particular, an arrangement may be adopted in which the vertices of the protrusions 15 are located on the imaginary circle C1 at regular intervals. For example, if there are three protrusions 15, the distance between adjacent protrusions 15 is 2π/3. If there are X protrusions 15, the distance between adjacent protrusions 15 is 2π/X. As a result of the vertices of the protrusions 15 being disposed at regular intervals as described above, the wire 20 is evenly held by the protrusions 15. Also, the individual protrusions 15 can hold the wire 20 with a uniform force. Thus, vibration can be distributed among and suppressed by the individual protrusions 15. Moreover, vibration can be suppressed by a configuration that is symmetrical in the circumferential direction, and therefore, vibration can be reduced even further.

In addition, for example, if the plurality of protrusions 15 are dispersed over a region corresponding to an arc that is half the imaginary circle C1, two protrusions located at opposite ends of that region can effectively suppress vibration by effectively clamping the wire 20.

In the embodiment given above, the transition section 13 is described as being substantially U-shaped in cross section perpendicular to the longitudinal direction (direction X); however, the transition section 13 is not limited to this shape. The transition section may have a rectangular shape, a circular shape, or other shapes in cross section perpendicular to the direction X.

Note that the configurations described in the embodiments and the variations given above can be combined as appropriate unless they are technically contradictory to each other.

Although the present disclosure has been described in detail above, the above description should be considered in all respects as illustrative, and the invention is not limited thereto. It should be understood that innumerable variations that are not illustrated herein can be envisaged without departing from the scope of the invention.

### LIST OF REFERENCE NUMERALS

1, 401 Wire with connecting terminal
10, 210, 310, 410, 510 Connecting terminal
11 Wire barrel section
11a First bottom wall portion
11b First projecting portion
11c Bent piece
12 Insulation barrel section
12a Second bottom wall portion
12b Second projecting portion
12c Bent piece
13, 213, 313, 413, 513 Transition section
13a Third bottom wall portion
13b Third projecting portion
14 Main body section
15, 215, 315, 415, 515 Protrusion
20 Wire
21 Core wire
22 Coating portion
516 Valley portion
517 Mountain portion

1. A connecting terminal comprising:
a wire barrel section;
an insulation barrel section; and
a transition section,
wherein the wire barrel section is configured to be crimped to a core wire exposed from a coating portion of a wire that includes the core wire and the coating portion coating the core wire,
the insulation barrel section is configured to be crimped to the coating portion,
the transition section connects the wire barrel section and the insulation barrel section to each other and includes at least one protrusion on a face that opposes the wire when the wire is crimped by the wire barrel section and the insulation barrel section, and
the protrusion is longer in a direction perpendicular to a longitudinal direction of the connecting terminal than in the longitudinal direction of the connecting terminal.

2. The connecting terminal according to claim 1,
wherein the transition section is inclined so as to gradually approach the wire while extending from the insulation barrel section toward the wire barrel section.

3. The connecting terminal according to claim 1,
wherein the at least one protrusion includes a plurality of protrusions.

4. The connecting terminal according to claim 3,
wherein, among the plurality of protrusions, at least two protrusions are disposed in the same plane which is perpendicular to a longitudinal direction of the connecting terminal.

5. The connecting terminal according to claim 4,
wherein, among the plurality of protrusions, at least one protrusion is disposed at a different position from each other protrusion in a longitudinal direction the connecting terminal.

6. The connecting terminal according to claim 3,
wherein three or more of the protrusions are disposed in the same plane which is perpendicular to a longitudinal direction of the connecting terminal, and
a diameter of an imaginary circle passing through vertices of the three or more protrusions is equal to or smaller than a diameter of the wire.

7. A wire with connecting terminal, comprising:
the connecting terminal according to claim 1; and
the wire crimped by the connecting terminal.

8. The wire with connecting terminal according to claim 7,
wherein the core wire is a single-core wire.

9. The wire with connecting terminal according to claim 7,
wherein the at least one protrusion abuts on the core wire or the coating portion.

10. A connecting terminal comprising:
a wire barrel section;
an insulation barrel section; and
a transition section,
wherein the wire barrel section is configured to be crimped to a core wire exposed from a coating portion of a wire that includes the core wire and the coating portion coating the core wire,
the insulation barrel section is configured to be crimped to the coating portion,
the transition section connects the wire barrel section and the insulation barrel section to each other and includes at least one protrusion on a face that opposes the wire when the wire is crimped by the wire barrel section and the insulation barrel section,
the protrusion is elongated in a plane perpendicular to a longitudinal direction of the connecting terminal, and
the protrusion further has an uneven shape in a direction in which the protrusion is elongated.

11. A connecting terminal comprising:
a wire barrel section;
an insulation barrel section; and
a transition section,
wherein the wire barrel section is configured to be crimped to a core wire exposed from a coating portion of a wire that includes the core wire and the coating portion coating the core wire,
the insulation barrel section is configured to be crimped to the coating portion,
the transition section connects the wire barrel section and the insulation barrel section to each other and includes at least one protrusion on a face that opposes the wire when the wire is crimped by the wire barrel section and the insulation barrel section, and
the transition section is inclined so as to gradually approach the wire in a width direction and a height direction while extending from the insulation barrel section toward the wire barrel section.

12. A connecting terminal comprising:
a wire barrel section;
an insulation barrel section; and
a transition section,
wherein the wire barrel section is configured to be crimped to a core wire exposed from a coating portion of a wire that includes the core wire and the coating portion coating the core wire,
the insulation barrel section is configured to be crimped to the coating portion,
the transition section connects the wire barrel section and the insulation barrel section to each other and includes at least one protrusion on a face that opposes the wire when the wire is crimped by the wire barrel section and the insulation barrel section,
three or more of the protrusions are disposed in the same plane which is perpendicular to a longitudinal direction of the connecting terminal, and
a diameter of an imaginary circle passing through vertices of the three or more protrusions is equal to or smaller than a diameter of the wire.
